(19) United States
(12) Patent Application Publication
(10) Pub. No.: US 2022/0308919 A1
(43) Pub. Date: Sep. 29, 2022

(54) PRIORITIZING SOFTWARE BUILD JOBS

(71) Applicant: International Business Machines Corporation, Armonk, NY (US)

(72) Inventors: Shrinidhi Atmakur, Bengaluru (IN); Natesh H Mariyappa, Bengaluru (IN); Raghavendra Rao Dhayapule, Bangalore (IN)

(21) Appl. No.: 17/211,583

(22) Filed: Mar. 24, 2021

(51) Int. Cl. G06F 9/48; G06F 8/41; G06N 20/00

(52) U.S. Cl. CPC G06F 9/4881; G06F 9/485; G06F 8/41; G06N 20/00

(57) ABSTRACT

A computer-implemented method, system and computer program product for executing build jobs more efficiently. A mathematical model is built using a machine learning algorithm to predict the priority of a build job using training data containing classifications of build jobs. After receiving one or more build jobs to be executed, such build jobs are classified. A priority is then assigned to these build jobs using the mathematical model based on the classifications. For example, the priorities of the build jobs from highest to lowest may correspond to those build jobs with the following classifications in descending order: customer deliverables, product deployment, staging deployment, pull request builds and development builds. The build jobs are then inserted at particular positions in a queue based on their assigned priority in a manner that causes the higher priority build jobs to be executed by the build tool prior to the lower priority build jobs.

### TECHNICAL FIELD

The present disclosure relates generally to software development, and more particularly to prioritizing software build jobs using a mathematical model based on classifications of the software build jobs and historical learning.

### BACKGROUND

Software development is the process of conceiving, specifying, designing, programming, documenting, testing, and bug fixing involved in creating and maintaining applications, frameworks, or other software components. Software development is a process of writing and maintaining the source code, but in a broader sense, it includes all that is involved between the conception of the desired software through to the final manifestation of the software, sometimes in a planned and structured process. Therefore, software development may include research, new development, prototyping, modification, reuse, re-engineering, maintenance, or any other activities that result in software products.

### SUMMARY

In one embodiment of the present disclosure, a computer-implemented method for executing build jobs more efficiently comprises building a mathematical model using a machine learning algorithm to predict a priority of a build job using training data containing classifications of build jobs. The method further comprises receiving one or more builds jobs to be executed. The method additionally comprises classifying the one or more build jobs. Furthermore, the method comprises assigning, using the mathematical model, a priority to each of the one or more build jobs based on the classifications of the one or more build jobs. Additionally, the method comprises inserting the one or more build jobs at particular positions in a queue based on the assigned priority.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the build process management system used to execute build jobs more efficiently in accordance with an embodiment of the present disclosure;

FIG. 3 illustrates an embodiment of the present disclosure of the hardware configuration of the build process management system which is representative of a hardware environment for practicing the present disclosure;

FIG. 4 is a flowchart of a method for executing build jobs more efficiently in accordance with an embodiment of the present disclosure; and

FIG. 5 illustrates the placement of build jobs in a build queue based on their assigned prioritization in accordance with an embodiment of the present disclosure.

### DETAILED DESCRIPTION

As stated in the Background section, software development is the process of conceiving, specifying, designing, programming, documenting, testing, and bug fixing involved in creating and maintaining applications, frameworks, or other software components. Software development is a process of writing and maintaining the source code, but in a broader sense, it includes all that is involved between the conception of the desired software through to the final manifestation of the software, sometimes in a planned and structured process. Therefore, software development may include research, new development, prototyping, modification, reuse, re-engineering, maintenance, or any other activities that result in software products.

In software engineering, a software development process is the process of dividing software development work into distinct phases to improve design, product management and project management. It is also known as a software development life cycle.

The software development life cycle is the application of standard business practices to building software applications. It is typically divided into six to eight steps, such as planning, requirements, design, build, document, test, deploy and maintain.

In software development, a build is the process of converting source code files into standalone software artifact(s) that can be run on a computer or the result of doing so. The process of building a computer program is usually managed by a build tool, a program that coordinates and controls other programs. Examples of such a program include Gradle®, Meister by OpenMake® Software, Ant®, Maven®, Rake, SCons and Phing.

In an attempt to optimize the software development life cycle and provide continuous delivery with high software quality, a process, known as “DevOps,” has been developed. DevOps is a set of practices that combines software development (Dev) and IT operations (Ops).

In the DevOps process, various tools, such as Jenkins® and Travis®, are used to help automate the parts of software development related to building, testing, and deploying, facilitating continuous integration (CI) and continuous delivery (CD).

Continuous integration (CI) refers to the practice of merging all software developers' working copies to a shared mainline several times a day. Continuous delivery (CD) is a software engineering approach in which teams produce software in short cycles, ensuring that the software can be reliably released at any time and, when releasing the software, doing so manually. It aims at building, testing, and releasing software with greater speed and frequency. The approach helps reduce the cost, time, and risk of delivering changes by allowing for more incremental updates to applications in production. A straightforward and repeatable deployment process is important for continuous delivery.

In the CI/CD pipeline, many software build jobs need to be executed. A “software build job,” as used herein, refers to a software build (process of converting source code files into standalone software artifact(s) that can be run on a computer or the result of doing so) that needs to be performed by the build tool of the software development system.

Currently though software development systems simply execute the software build jobs as they are received. As a result, software build jobs may not be executed in a manner that optimizes the software development life cycle and provides continuous delivery with high software quality.

The embodiments of the present disclosure provide a means for executing software build jobs in a manner that shortens the software development life cycle and provides continuous delivery with high software quality by prioritizing build jobs based on the attributes of the build jobs and historical learning and then executing the build jobs based on such prioritization.

In some embodiments of the present disclosure, the present disclosure comprises a computer-implemented method, system and computer program product for executing build jobs more efficiently. In one embodiment of the present disclosure, a mathematical model (machine learning model) is built using a machine learning algorithm to predict the priority of a build job using training data. In one embodiment, the machine learning algorithm (e.g., supervised learning) builds the mathematical model based on sample data consisting of structured and unstructured data (e.g., priorities assigned to build jobs based on classifications of the build jobs). After receiving one or more build jobs to be executed, such build jobs are classified. In one embodiment, the build jobs are classified according to one of the following classifications: customer deliverables, production deployment, staging deployment, pull request builds and development builds. The mathematical model then assigns a priority to these build jobs based on the classifications. For example, the priorities of the build jobs from highest to lowest may correspond to those build jobs with the following classifications in descending order: customer deliverables, product deployment, staging deployment, pull request builds and development builds. For instance, a build request with the classification of production deployment is assigned a higher priority than a build request with the classification of staging deployment. The build jobs are then inserted at particular positions in a build queue based on the assigned priority in a manner that causes the higher priority build jobs to be executed by the build tool prior to the lower priority build jobs. As a result, the software development life cycle is optimized while providing continuous delivery with high software quality.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

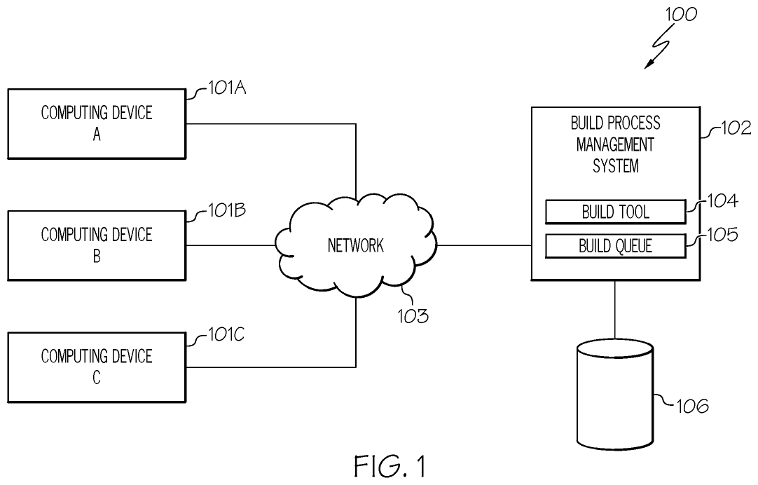

Referring now to the Figures in detail, FIG. 1 illustrates an embodiment of the present disclosure of a communication system 100 for practicing the principles of the present disclosure. Communication system 100 includes computing devices 101A-101C (identified as “Computing Device A,” “Computing Device B,” and “Computing Device C,” respectively, in FIG. 1) connected to a build process management system 102 via a network 103. Computing devices 101A-101C may collectively or individually be referred to as computing devices 101 or computing device 101, respectively. It is noted that both computing devices 101 and the users (software developers) of computing devices 101 may be identified with element number 101.

Computing device 101 may be any type of computing device (e.g., portable computing unit, Personal Digital Assistant (PDA), laptop computer, mobile device, tablet personal computer, smartphone, mobile phone, navigation device, gaming unit, desktop computer system, workstation, Internet appliance and the like) configured with the capability of connecting to network 103 and consequently communicating with other computing devices 101 and build process management system 102.

Network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

Build process management system 102 may be a computing device, system or environment utilized by users 101 (software developers) to develop software. For example, users 101 may utilize build process management system 102 to build software applications, such as during the build step of the software development life cycle.

In one embodiment, build process management system 102 is configured to execute software build jobs in a manner that optimizes the software development life cycle and provides continuous delivery with high software quality as discussed further below.

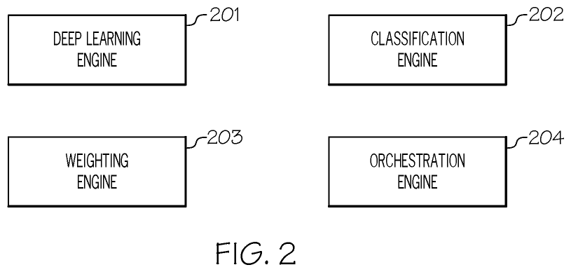

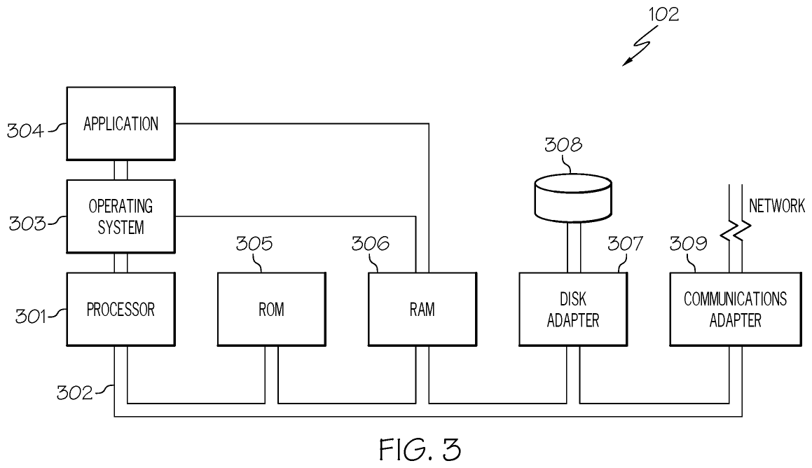

As previously discussed, users 101 (e.g., software developers) may utilize build process management system 102 to build software applications. In one embodiment, the build operation is performed by a build tool 104 (e.g., Gradle®, Meister by OpenMake® Software, Ant®, Maven®, Rake, SCons and Phing) of build process management system 102. In one embodiment, build tool 104 is a program that automates the creation of executable applications from source code. Such a process is referred to herein as “executing the software build.” In connection with executing software builds, build tool 104 performs the build operation for each “build job.” A “build job,” as used herein, refers to the source code that needs to be converted into executable applications or standalone software artifact(s) that can be run a computer. In one embodiment, such build jobs are stored in a queue 105 (“build queue”) and are dynamically executed by build tool 104 based on a priority assigned to the build jobs by build process management system 102 as discussed further below. In this manner, build process management system 102 executes software build jobs in a manner that optimizes the software development life cycle and provides continuous delivery with high software quality. A description of the software components of build process management system 102 is provided below in connection with FIG. 2 and a description of the hardware configuration of build process management system 102 is provided further below in connection with FIG. 3.

Furthermore, as illustrated in FIG. 1, system 100 includes a repository 106 connected to build process management system 102. In one embodiment, repository 106 stores metadata that includes the classifications of the build jobs examined by build process management system 102 as discussed further below.

System 100 is not to be limited in scope to any one particular network architecture. System 100 may include any number of computing devices 101, build process management systems 102, networks 103 and repositories 106.

A discussion regarding the software components used by build process management system 102 to execute software build jobs is discussed below in connection with FIG. 2.

FIG. 2 is a diagram of the software components of build process management system 102 (FIG. 1) used to execute build jobs more efficiently in accordance with an embodiment of the present disclosure.

Referring to FIG. 2, in conjunction with FIG. 1, build process management system 102 includes a deep learning engine 201 which uses a machine learning algorithm (e.g., supervised learning) to build a mathematical model based on sample data consisting of structured and unstructured data (e.g., priorities assigned to build jobs based on classifications of the build jobs). Such structured and unstructured data may be obtained and tabulated by experts, who in turn, utilize such information to develop the sample data. Such a data set is referred to herein as the “training data” which is used by the machine learning algorithm of deep learning engine 201 to make predictions or decisions without being explicitly programmed to perform the task. In one embodiment, the training data consists of classifications of sample build jobs (e.g., customer deliverables, production deployment, staging deployment, pull request builds, development builds, etc.) and their associated priorities. The algorithm iteratively makes predictions on the training data and is corrected by the expert until the predictions achieve the desired accuracy. Examples of such supervised learning algorithms include nearest neighbor, Naïve Bayes, decision trees, linear regression, support vector machines and neural networks.

In one embodiment, the mathematical model (machine learning model) corresponds to a classification model trained to predict the priority of the build jobs based on classifications of the build jobs, such as customer deliverables, production deployment, staging deployment, pull request builds, development builds, etc.

Build process management system 102 further includes a classification engine 202 configured to classify the build jobs. “Classifications,” as used herein, refer to the categories or groups in which build jobs are assigned based on the analysis of the build jobs by classification engine 202. Examples of such classifications include customer deliverables, production deployment, staging deployment, pull request builds and development builds.

A customer deliverable, as used herein, refers to a build job that is provided by and/or intended to be delivered to the customer. For example, the customer deliverable may correspond to a build job to be delivered to the customer, such as a customer patch build. A “patch,” as used herein, refers to a set of changes to a computer program or its supporting data designed to update, fix or improve it. A “patch build,” refers to the source code with the set of changes to the computer program or its supporting data designed to update, fix or improve it. Such a build job may be said to be a “customer deliverable build job.”

Production deployment, as used herein, refers to the process of running an application on a server or computing device. For example, the production deployment may correspond to continuous delivery deployment types, such as minimum in-service deployment, rolling application updates, blue/green deployment, A/B testing, etc. In the context of build jobs, a build job may be to test the production deployment on a platform as a service (e.g., Heroku®). Such a build job may be said to be a “production deployment build job.”

Staging deployment, as used herein, refers to the staging or pre-production environment for testing that exactly resembles a production environment. For example, servers may run on remote machines rather than locally (as on a developer's workstation during development or on a single test machine during test), which tests the effects of networking on the system. In one embodiment, the primary use of the staging environment is to test all the installation/configuration/migration scripts and procedures before they have been applied to a production environment. This ensures that all major and minor upgrades to a production environment are completed reliably, without errors, and in a minimum of time. Staging is also used by some organizations to preview new features to select customers or to validate integrations with live versions of external dependencies.

In the context of build jobs, source code may be developed to test the staging deployment on a platform as a service (e.g., Heroku®). Such a build job may be said to be a “staging deployment build job.”

Pull request (PR) builds, as used herein, refer to pull request jobs (source code) that are used to notify team members, such as members on a software development team, that a feature has been completed.

Development builds, as used herein, refer to the source code being developed by the software developers that needs to be built in the early stages of the software development process.

As discussed above, such classifications are assigned to the build jobs by classification engine 202. In one embodiment, classification engine 202 utilizes natural language processing to determine the classification to assign the build job based on identifying certain terms or keywords in the source code associated with the build job. In one embodiment, classification engine 202 utilizes a data structure (e.g., table) containing a list of terms and associated build job classifications. For example, the term “completed” may be associated with the pull request build classification. In another example, the phrase “minimum in-service deployment” may be associated with the production deployment build classification.

In one embodiment, classification engine 202 identifies the source of the build job, such as being received from a customer. Such a build job has the classification of a customer deliverable. For example, classification engine 202 may examine the domain name of the e-mail sending the build job. Based on the domain name, classification engine 202 may determine that the build job is from a customer. In one embodiment, a data structure (e.g., list) containing a listing of domain names and recognized customers may be utilized by classification engine 202 to determine if the build job is from a customer. In one embodiment, such a data structure is stored in a storage device (e.g., memory, disk drive) of build process management system 102 or in repository 106.

In one embodiment, classifications are assigned to the build jobs by user 101 (software developer). For example, user 101 (software developer) may indicate that the build job is a customer deliverable, such as via selecting an option on a menu displayed to user 101 containing a list of classifications to be associated with the build jobs. Such classifications assigned to the build jobs by user 101 may then be provided to classification engine 202 of build process management system 102 by user 101. Classification engine 202 may then classify the build job accordingly.

In one embodiment, the classifications of the build jobs discussed above may be stored as metadata in repository 106.

Build processing management system 102 further includes a weighting engine 203 configured to assign a weight value to the build jobs in the event of having multiple build jobs assigned the same classification. In one embodiment, weighting engine 203 will assign a weight value to the build jobs based on attributes, such as an estimated build time, a time of receipt of the build job, etc. For example, the estimated build time may be estimated by weighting engine 203 based on the number of lines of source code. The greater the number of lines of source code, the greater the estimated build time and vice-versa. In one embodiment, the shorter the estimated build time, the higher the weight value assigned to the build job and vice-versa. In one embodiment, the earlier the time of receipt of the build job, the higher the weight value assigned to the build job and vice-versa. In one embodiment, the weight values assigned to the build job may be normalized between the values of 0 and 1. In the scenario in which multiple build jobs are classified with the same classification, the build job assigned a higher weight value will be placed higher in build queue 105 (i.e., ranked higher) than the build job assigned a lower weight value.

As discussed above, build process management system 102 includes a deep learning engine 201 which uses a machine learning algorithm (e.g., supervised learning) to build a mathematical model to predict a priority for the build jobs. In one embodiment, deep learning engine 201 assigns a priority (or ranking) to the build jobs using the mathematical model based on the build job classifications. In one embodiment, deep learning engine 201 may assign a priority to the build jobs based on the build job classification as well as the weight values (if applicable) and historical learning.

As discussed above, deep learning engine 201 may assign a priority to the build jobs using the mathematical model based on the classifications of the build jobs. In one embodiment, the priorities of the build jobs from highest to lowest may correspond to those build jobs with the following classifications in descending order: customer deliverables, product deployment, staging deployment, pull request builds and development builds. For example, a build request with the classification of production deployment is assigned a higher priority than a build request with the classification of staging deployment.

While the description herein discusses classifications, such as customer deliverables, production deployment, staging deployment, pull request builds and development builds, the principles of the present disclosure are not to be limited to such classifications and may include other classifications that can be used to prioritize build jobs. A person of ordinary skill in the art would be capable of applying the principles of the present disclosure to such implementations. Further, embodiments applying the principles of the present disclosure to such implementations would fall within the scope of the present disclosure.

Furthermore, while the description herein discusses build priorities in descending order of the following classifications: customer deliverables, production deployment, staging deployment, pull request builds and development builds, the principles of the present disclosure are not to be limited to assigning build priorities based on such an order. For example, build jobs classified as staging deployment build jobs may be assigned a higher priority than build jobs classified as production deployment build jobs. A person of ordinary skill in the art would be capable of applying the principles of the present disclosure to such implementations. Further, embodiments applying the principles of the present disclosure to such implementations would fall within the scope of the present disclosure.

In one embodiment, the mathematical model discussed above may dynamically adjust the build priorities based on historical learning. For example, such learning may involve learning how the various build jobs (e.g., development builds, pull request builds) behave. For instance, certain build jobs may have more or less issues during the build process than other build jobs. For example, certain build jobs may have more or less issues during the build process, which consists of fetching the code from a source control repository, compiling the code and checking the dependencies/modules, running the automated unit tests, linking the libraries, code, files, etc., building the artifacts, storing the artifacts, archiving the build logs and sending the notification e-mails. The success or failures of such steps in the build process for each type of build job (e.g., development builds, pull request builds) may be tabulated and stored for analysis. Those types of build jobs that are less successful than other types of build jobs may be assigned a lower priority. For example, those build jobs with the classification of production development may have originally been assigned a higher priority than those build jobs with the classification of staging development. However, based on historical learning by the mathematical model, deep learning engine 201 using the mathematical model may dynamically adjust the build priorities so that those build jobs with the classification of staging development are assigned a higher priority than those build jobs with the classification of production development due to the failures in the build process for those build jobs with the classification of production development.

In one embodiment, deep learning engine 201, using the mathematical model, dynamically determines the priority of a build job at runtime.

Referring again to FIG. 2, build process management system 102 may further include an orchestration engine 204 configured to insert the build jobs in build queue 105 based on their assigned priority. In one embodiment, build jobs are placed in the top position downwards in build queue 105 based on their assigned priority from highest to lowest. In one embodiment, such placement may correspond to reordering the build jobs previously placed in build queue 105. In this manner, higher priority build jobs will be executed by build tool 104 prior to lower priority build jobs thereby optimizing the software development life cycle while providing continuous delivery with high software quality.

A further description of these and other functions is provided below in connection with the discussion of the method for executing build jobs more efficiently.

Prior to the discussion of the method for executing build jobs more efficiently, a description of the hardware configuration of build process management system 102 (FIG. 1) is provided below in connection with FIG. 3.

Referring now to FIG. 3, FIG. 3 illustrates an embodiment of the present disclosure of the hardware configuration of build process management system 102 (FIG. 1) which is representative of a hardware environment for practicing the present disclosure.

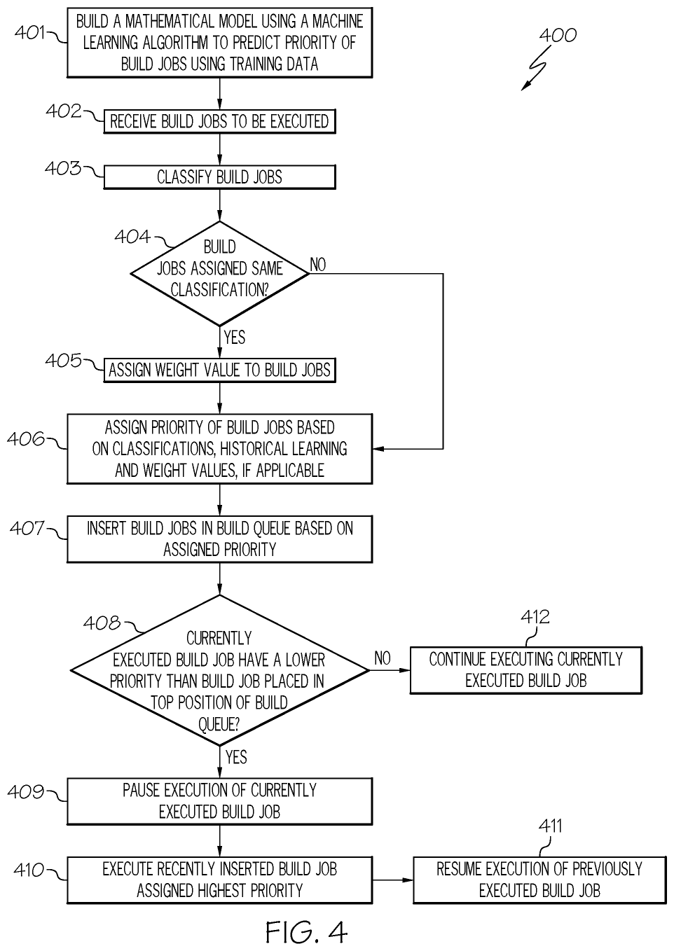

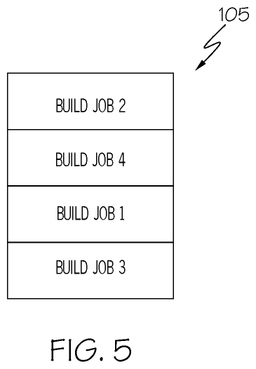

Build process management system 102 has a processor 301 connected to various other components by system bus 302. An operating system 303 runs on processor 301 and provides control and coordinates the functions of the various components of FIG. 3. An application 304 in accordance with the principles of the present disclosure runs in conjunction with operating system 303 and provides calls to operating system 303 where the calls implement the various functions or services to be performed by application 304. Application 304 may include, for example, deep learning engine 201 (FIG. 2), classification engine 202 (FIG. 2), weighting engine 203 (FIG. 2) and orchestration engine 204 (FIG. 2). Furthermore, application 304 may include, for example, a program for executing build jobs more efficiently as discussed further below in connection with FIGS. 4-5.

Referring again to FIG. 3, read-only memory (“ROM”) 305 is connected to system bus 302 and includes a basic input/output system (“BIOS”) that controls certain basic functions of build process management system 102. Random access memory (“RAM”) 306 and disk adapter 307 are also connected to system bus 302. It should be noted that software components including operating system 303 and application 304 may be loaded into RAM 306, which may be build process management system's 102 main memory for execution. Disk adapter 307 may be an integrated drive electronics (“IDE”) adapter that communicates with a disk unit 308, e.g., disk drive. It is noted that the program for executing build jobs more efficiently, as discussed further below in connection with FIGS. 4-5, may reside in disk unit 308 or in application 304.

Build process management system 102 may further include a communications adapter 309 connected to bus 302. Communications adapter 309 interconnects bus 302 with an outside network (e.g., network 103 of FIG. 1) to communicate with other devices, such as computing devices 101, etc.

In one embodiment, application 304 of build process management system 102 includes the software components of deep learning engine 201, classification engine 202, weighting engine 203 and orchestration engine 204. In one embodiment, such components may be implemented in hardware, where such hardware components would be connected to bus 302. The functions discussed above performed by such components are not generic computer functions. As a result, build process management system 102 is a particular machine that is the result of implementing specific, non-generic computer functions.

In one embodiment, the functionality of such software components (e.g., deep learning engine 201, classification engine 202, weighting engine 203 and orchestration engine 204) of build process management system 102, including the functionality for executing build jobs more efficiently, may be embodied in an application specific integrated circuit.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As stated above, in software engineering, a software development process is the process of dividing software development work into distinct phases to improve design, product management and project management. It is also known as a software development life cycle. The software development life cycle is the application of standard business practices to building software applications. It is typically divided into six to eight steps, such as planning, requirements, design, build, document, test, deploy and maintain. In software development, a build is the process of converting source code files into standalone software artifact(s) that can be run on a computer or the result of doing so. The process of building a computer program is usually managed by a build tool, a program that coordinates and controls other programs. Examples of such a program include Gradle®, Meister by OpenMake® Software, Ant®, Maven®, Rake, SCons and Phing. In an attempt to optimize the software development life cycle and provide continuous delivery with high software quality, a process, known as “DevOps,” has been developed. DevOps is a set of practices that combines software development (Dev) and IT operations (Ops). In the DevOps process, various tools, such as Jenkins® and Travis®, are used to help automate the parts of software development related to building, testing, and deploying, facilitating continuous integration (CI) and continuous delivery (CD). In the Cl/CD pipeline, many software build jobs need to be executed. A “software build job,” as used herein, refers to a software build (process of converting source code files into standalone software artifact(s) that can be run on a computer or the result of doing so) that needs to be performed by the build tool of the software development system. Currently though software development systems simply execute the software build jobs as they are received. As a result, software build jobs may not be executed in a manner that optimizes the software development life cycle and provides continuous delivery with high software quality.

The embodiments of the present disclosure provide a means for executing software build jobs in a manner that optimizes the software development life cycle and provides continuous delivery with high software quality by prioritizing build jobs based on the classifications of the build jobs and historical learning and then executing the build jobs based on such prioritization as discussed below in connection with FIGS. 4-5. FIG. 4 is a flowchart of a method for executing build jobs more efficiently. FIG. 5 is a diagram illustrating the placement of build jobs in a build queue based on their assigned prioritization.

As discussed above, FIG. 4 is a flowchart of a method 400 for executing build jobs more efficiently in accordance with an embodiment of the present disclosure.

Referring to FIG. 4, in conjunction with FIGS. 1-3, in operation 401, deep learning engine 201 of build process management system 102 builds a mathematical model using a machine learning engine to predict the priority of build jobs using training data.

As discussed above, in one embodiment, deep learning engine 201 uses a machine learning algorithm (e.g., supervised learning) to build a mathematical model based on sample data consisting of structured and unstructured data (e.g., priorities assigned to build jobs based on classifications of the build jobs). Such structured and unstructured data may be obtained and tabulated by experts, who in turn, utilize such information to develop the sample data. Such a data set is referred to herein as the “training data” which is used by the machine learning algorithm of deep learning engine 201 to make predictions or decisions without being explicitly programmed to perform the task. In one embodiment, the training data consists of classifications of sample build jobs (e.g., customer deliverables, production deployment, staging deployment, pull request builds, development builds, etc.) and their associated priorities. The algorithm iteratively makes predictions on the training data and is corrected by the expert until the predictions achieve the desired accuracy. Examples of such supervised learning algorithms include nearest neighbor, Naive Bayes, decision trees, linear regression, support vector machines and neural networks.

In one embodiment, the mathematical model (machine learning model) corresponds to a classification model trained to predict the priority of the build jobs based on classifications of the build jobs, such as customer deliverables, production deployment, staging deployment, pull request builds, development builds, etc.

After the mathematical model (machine learning model) has been deemed to achieve the desired accuracy, in operation 402, build process management system 102 receives the build jobs to be executed. In one embodiment, such build jobs correspond to the build jobs in the Cl/CD pipeline. In one embodiment, such build jobs may be queued in a queue ready to be inserted in build queue 105 according to their priority.

As discussed above, a “build job” (also referred to as a “software build job”) refers to a software build that needs to be performed by build tool 104. In one embodiment, such a software build may be received from user 101 (software developer). For example, software developer 101 may be developing source code to test the staging deployment on a platform as a service (e.g., Heroku®). Such source code may then need to be built by build tool 104. As previously discussed, such a build is the process of converting source code files into standalone software artifact(s) that can be run on a computer or the result of doing so. The job for performing such a build on the source code being developed by software developer 101 is referred to herein as the “build job.”

In one embodiment, such build jobs may be in the CI/CD pipeline waiting to be classified, prioritized and inserted in build queue 105 for execution by build tool 104.

In one embodiment, prior to receiving such build job(s), build tool 104 may already have a quantity of build jobs to be performed. In one embodiment, such build jobs are stored in a queue, such as build queue 105. In one embodiment, the prioritization of such build jobs were previously performed by the mathematical model (machine learning model) discussed above at runtime prior to receiving a further build job in operation 402.

In operation 403, classification engine 202 of build process management system 102 classifies the received build jobs. As discussed above, “classifications,” as used herein, refer to the categories or groups in which build jobs are assigned based on the analysis of the build jobs by classification engine 202. Examples of such classifications include customer deliverables, production deployment, staging deployment, pull request builds and development builds.

As also discussed above, such classifications are assigned to the build jobs by classification engine 202. In one embodiment, classification engine 202 utilizes natural language processing to determine the classification to assign the build job based on identifying certain terms or keywords in the source code associated with the build job. In one embodiment, classification engine 202 utilizes a data structure (e.g., table) containing a list of terms and associated build job classifications. For example, the term “completed” may be associated with the pull request build classification. In another example, the phrase “minimum in-service deployment” may be associated with the production deployment build classification.

In one embodiment, classification engine 202 identifies the source of the build job, such as being received from a customer. Such a build job has the classification of a customer deliverable. For example, classification engine 202 may examine the domain name of the e-mail sending the build job. Based on the domain name, classification engine 202 may determine that the build job is from a customer. In one embodiment, a data structure (e.g., list) containing a listing of domain names and recognized customers may be utilized by classification engine 202 to determine if the build job is from a customer. In one embodiment, such a data structure is stored in a storage device (e.g., memory, disk drive) of build process management system 102 or in repository 106.

In one embodiment, classifications are assigned to the build jobs by user 101 (software developer). For example, user 101 (software developer) may indicate that the build job is a customer deliverable, such as via selecting an option on a menu displayed to user 101 containing a list of classifications to be associated with the build jobs. Such classifications assigned to the build jobs by user 101 may then be provided to classification engine 202 of build process management system 102 by user 101. Classification engine 202 may then classify the build job accordingly.

In one embodiment, the classifications of the build jobs discussed above may be stored as metadata in repository 106.

In operation 404, a determination is made by classification engine 202 as to whether any build jobs are assigned the same classification.

If there are build jobs assigned the same classification, then, in operation 405, weighting engine 203 of build process management system 102 assigns a weight value to the build jobs.

As discussed above, in one embodiment, weighting engine 203 will assign a weight value to the build jobs based on attributes, such as an estimated build time, a time of receipt of the build job, etc. For example, the estimated build time may be estimated by weighting engine 203 based on the number of lines of source code. The greater the number of lines of source code, the greater the estimated build time and vice-versa. In one embodiment, the shorter the estimated build time, the higher the weight value assigned to the build job and vice-versa. In one embodiment, the earlier the time of receipt of the build job, the higher the weight value assigned to the build job and vice-versa. In one embodiment, the weight values assigned to the build job may be normalized between the values of 0 and 1. In the scenario in which multiple build jobs are classified with the same classification, the build job assigned a higher weight value will be placed higher in build queue 105 (i.e., ranked higher) than the build job assigned a lower weight value.

Upon assigning a weight value to the build jobs, or if there are no build jobs assigned the same classification, then, in operation 406, deep learning engine 201 of build process management system 102 assigns the priority to the received build jobs using the mathematical model based on the classifications, historical learning and weight values, if applicable.

As discussed above, deep learning engine 201 may assign a priority to the build jobs using the mathematical model based on the classifications of the build jobs. In one embodiment, the priorities of the build jobs from highest to lowest may correspond to those build jobs with the following classifications in descending order: customer deliverables, product deployment, staging deployment, pull request builds and development builds. For example, a build request with the classification of production deployment is assigned a higher priority than a build request with the classification of staging deployment.

In one embodiment, the mathematical model discussed above may dynamically adjust the build priorities based on historical learning. For example, such learning may involve learning how the various build jobs (e.g., development builds, pull request builds) behave. For instance, certain build jobs may have more or less issues during the build process than other build jobs. For example, certain build jobs may have more or less issues during the build process, which consists of fetching the code from a source control repository, compiling the code and checking the dependencies/modules, running the automated unit tests, linking the libraries, code, files, etc., building the artifacts, storing the artifacts, archiving the build logs and sending the notification e-mails. The success or failures of such steps in the build process for each type of build job (e.g., development builds, pull request builds) may be tabulated and stored for analysis. Those types of build jobs that are less successful than other types of build jobs may be assigned a lower priority. For example, those build jobs with the classification of production development may have originally been assigned a higher priority than those build jobs with the classification of staging development. However, based on historical learning by the mathematical model, deep learning engine 201 using the mathematical model may dynamically adjust the build priorities so that those build jobs with the classification of staging development are assigned a higher priority than those build jobs with the classification of production development due to the failures in the build process for those build jobs with the classification of production development.

Furthermore, as discussed above, deep learning engine 201 may assign a higher or lower priority to the build jobs with the same classification using the weighting value provided by weighting engine 203. For example, those build jobs with the same classification with a higher weighting value will have a higher priority than those with a lower weighting value.

In one embodiment, deep learning engine 201, using the mathematical model, dynamically determines the priority of a build job at runtime.

In operation 407, orchestration engine 204 of build process management system 102 inserts the build jobs in particular positions of build queue 105 based on their assigned priority. In one embodiment, build jobs are placed in the top position downwards in build queue 105 based on their assigned priority from highest to lowest. In one embodiment, such placement may correspond to reordering the build jobs previously placed in build queue 105. In this manner, higher priority build jobs will be executed by build tool 104 prior to lower priority build jobs thereby optimizing the software development life cycle while providing continuous delivery with high software quality.

An example of inserting the build jobs in particular positions of build queue 105 is shown in FIG. 5.

FIG. 5 illustrates the placement of build jobs in a build queue 105 (FIG. 1) based on their assigned prioritization in accordance with an embodiment of the present disclosure.

Referring to FIG. 5, in conjunction with FIG. 1, build queue 105 stores the build jobs to be performed by build tool 104 that are ordered in build queue 105 based on their assigned priority. For example, FIG. 5 illustrates that build job 2 is placed higher in build queue 105 than build job 4 which is placed higher in build queue 105 than build job 1 which is placed higher in build queue 105 than build job 3. In other words, build job 2 is assigned a higher priority than build job 4 which is assigned a higher priority than build job 1 which is assigned a higher priority than build job 3. For example, priorities may be assigned, in part, from higher to lower based on the classifications of the build jobs. For instance, the following classifications (in descending order) will be assigned priorities from higher to lower: customer deliverables, production deployment, staging deployment, pull request builds and development builds. For example, build jobs classified as production deployment build jobs will be assigned a higher priority than build jobs classified as staging deployment build jobs. As previously discussed, such build jobs are classified by classification engine 202. Based on such classifications, priorities may be assigned by learning engine 201.

For example, if build jobs 2, 4, 1 and 3 were classified as a production deployment build job, a staging deployment build job, a pull request build and a development build, respectively, then based on such classifications, build job 2 will be assigned a higher priority than build job 4 which will be assigned a higher priority than build job 1 which will be assigned a higher priority than build job 3 based on assigning priorities (from higher to lower) to the following classifications (in descending order): customer deliverables, production deployment, staging deployment, pull request builds and development builds.

Once the build jobs are placed in build queue 105, they will be executed in the order of priority by build tool 104. That is, once the build jobs are placed in build queue 105, they will be executed from the top position downwards by build tool 104.

While the foregoing discusses classifications, such as customer deliverables, production deployment, staging deployment, pull request builds and development builds, the principles of the present disclosure are not to be limited to such classifications and may include other classifications that can be used to prioritize build jobs. A person of ordinary skill in the art would be capable of applying the principles of the present disclosure to such implementations. Further, embodiments applying the principles of the present disclosure to such implementations would fall within the scope of the present disclosure.

In operation 408, a determination is made by build process management system 102 as to whether there is a currently executed build job with a lower priority than the build job inserted in the highest position of build queue 105 (build job assigned the highest priority).

If there is a currently executed build job with a lower priority than the build job inserted in the highest position of build queue 105, then, in operation 409, build process management system 102 pauses the execution of the currently executed build job. For example, if the build job inserted in the highest position of build queue 105 that is assigned the highest priority corresponds to a customer patch (with the classification of a customer deliverable) and the build job currently being executed is a production deployment build job, and if a customer deliverable build job is assigned a higher priority than the production deployment build job, then build process management system 102 pauses the execution of the production deployment build job.

In operation 410, build tool 104 of build process management system 102 executes the recently inserted build job assigned the highest priority. In this manner, by always executing the build job with the highest priority, the build jobs will be more efficiently executed thereby optimizing the software development life cycle while providing continuous delivery with high software quality.

In operation 411, build tool 104 of build process management system 102 resumes execution of the previously executed build job, such as upon completion of the execution of the recently inserted build job assigned the highest priority. In one embodiment, the resumption of such a build job may occur when there are no further build jobs stored in build queue 105 with a higher priority. If there are other build jobs in build queue 105 with a higher priority than the previously executed build job, then the execution of the previously executed build job may remain paused until all the other build jobs with a higher priority are executed or until a threshold amount of time has elapsed, which may be user-designated.

If, however, the currently executed build job has a higher priority than the build job inserted in the highest position of build queue 105, then, in operation 412, build tool 104 of build process management system 102 continues to execute the currently executed build job.

As a result of the foregoing, embodiments of the present disclosure execute the software build jobs in a manner that optimizes the software development life cycle while providing continuous delivery with high software quality by prioritizing build jobs based on the classifications of the build jobs and historical learning and then executing the build jobs based on such prioritization.

Furthermore, the principles of the present disclosure improve the technology or technical field involving software development. As discussed above, in software engineering, a software development process is the process of dividing software development work into distinct phases to improve design, product management and project management. It is also known as a software development life cycle. The software development life cycle is the application of standard business practices to building software applications. It is typically divided into six to eight steps, such as planning, requirements, design, build, document, test, deploy and maintain. In software development, a build is the process of converting source code files into standalone software artifact(s) that can be run on a computer or the result of doing so. The process of building a computer program is usually managed by a build tool, a program that coordinates and controls other programs. Examples of such a program include Gradle®, Meister by OpenMake® Software, Ant®, Maven®, Rake, SCons and Phing. In an attempt to optimize the software development life cycle and provide continuous delivery with high software quality, a process, known as “DevOps,” has been developed. DevOps is a set of practices that combines software development (Dev) and IT operations (Ops). In the DevOps process, various tools, such as Jenkins® and Travis®, are used to help automate the parts of software development related to building, testing, and deploying, facilitating continuous integration (CI) and continuous delivery (CD). In the Cl/CD pipeline, many software build jobs need to be executed. A “software build job,” as used herein, refers to a software build (process of converting source code files into standalone software artifact(s) that can be run on a computer or the result of doing so) that needs to be performed by the build tool of the software development system. Currently though software development systems simply execute the software build jobs as they are received. As a result, software build jobs may not be executed in a manner that optimizes the software development life cycle and provides continuous delivery with high software quality.

Embodiments of the present disclosure improve such technology by executing build jobs more efficiently. In one embodiment, a mathematical model (machine learning model) is built using a machine learning algorithm to predict the priority of a build job using training data. In one embodiment, the machine learning algorithm (e.g., supervised learning) builds the mathematical model based on sample data consisting of structured and unstructured data (e.g., priorities assigned to build jobs based on classifications of the build jobs). After receiving one or more build jobs to be executed, such build jobs are classified. In one embodiment, the build jobs are classified according to one of the following classifications: customer deliverables, production deployment, staging deployment, pull request builds and development builds. The mathematical model then assigns a priority to these build jobs based on the classifications. For example, the priorities of the build jobs from highest to lowest may correspond to those build jobs with the following classifications in descending order: customer deliverables, product deployment, staging deployment, pull request builds and development builds. For instance, a build request with the classification of production deployment is assigned a higher priority than a build request with the classification of staging deployment. The build jobs are then inserted at particular positions in a build queue based on the assigned priority in a manner that causes the higher priority build jobs to be executed by the build tool prior to the lower priority build jobs. As a result, the software development life cycle is optimized while providing continuous delivery with high software quality. Furthermore, in this manner, there is an improvement in the technical field involving software development.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for executing build jobs more efficiently, the method comprising:
building a mathematical model using a machine learning algorithm to predict a priority of a build job using training data containing classifications of build jobs;
receiving one or more builds jobs to be executed;
classifying said one or more build jobs;
assigning, using said mathematical model, a priority to each of said one or more build jobs based on said classifications of said one or more build jobs; and
inserting said one or more build jobs at particular positions in a queue based on said assigned priority.

2. The method as recited in claim 1, wherein said priority is assigned to each of said one or more build jobs based on said classifications of said one or more build jobs and historical learning.

3. The method as recited in claim 1, wherein a first build job of said one or more build jobs is inserted in said queue, the method further comprising:
pausing an execution of a second build job currently being executed in response to a priority assigned to said first build job being a higher priority than a priority assigned to said second build job.

4. The method as recited in claim 3 further comprising:
executing said first build job after pausing said execution of said second build job.

5. The method as recited in claim 4 further comprising:
resuming execution of said second build job in response to completion of said execution of said first build job.

6. The method as recited in claim 1, wherein said classifications of said one or more build jobs comprise one or more of the following: customer deliverables, production deployment, staging deployment, pull request builds, and development builds.

7. The method as recited in claim 1, wherein said machine learning algorithm is a supervised learning algorithm.

8. A computer program product for executing build jobs more efficiently, the computer program product comprising one or more computer readable storage mediums having program code embodied therewith, the program code comprising programming instructions for:
building a mathematical model using a machine learning algorithm to predict a priority of a build job using training data containing classifications of build jobs;
receiving one or more builds jobs to be executed;
classifying said one or more build jobs;
assigning, using said mathematical model, a priority to each of said one or more build jobs based on said classifications of said one or more build jobs; and
inserting said one or more build jobs at particular positions in a queue based on said assigned priority.

9. The computer program product as recited in claim 8, wherein said priority is assigned to each of said one or more build jobs based on said classifications of said one or more build jobs and historical learning.

10. The computer program product as recited in claim 8, wherein a first build job of said one or more build jobs is inserted in said queue, wherein the program code further comprises the programming instructions for:
pausing an execution of a second build job currently being executed in response to a priority assigned to said first build job being a higher priority than a priority assigned to said second build job.

11. The computer program product as recited in claim 10, wherein the program code further comprises the programming instructions for:
executing said first build job after pausing said execution of said second build job.

12. The computer program product as recited in claim 11, wherein the program code further comprises the programming instructions for:
resuming execution of said second build job in response to completion of said execution of said first build job.

13. The computer program product as recited in claim 8, wherein said classifications of said one or more build jobs comprise one or more of the following: customer deliverables, production deployment, staging deployment, pull request builds, and development builds.

14. The computer program product as recited in claim 8, wherein said machine learning algorithm is a supervised learning algorithm.

15. A system, comprising:
a memory for storing a computer program for executing build jobs more efficiently; and
a processor connected to said memory, wherein said processor is configured to execute program instructions of the computer program comprising:
building a mathematical model using a machine learning algorithm to predict a priority of a build job using training data containing classifications of build jobs;
receiving one or more builds jobs to be executed;
classifying said one or more build jobs;
assigning, using said mathematical model, a priority to each of said one or more build jobs based on said classifications of said one or more build jobs; and
inserting said one or more build jobs at particular positions in a queue based on said assigned priority.

16. The system as recited in claim 15, wherein said priority is assigned to each of said one or more build jobs based on said classifications of said one or more build jobs and historical learning.

17. The system as recited in claim 15, wherein a first build job of said one or more build jobs is inserted in said queue, wherein the program instructions of the computer program further comprise:
pausing an execution of a second build job currently being executed in response to a priority assigned to said first build job being a higher priority than a priority assigned to said second build job.

18. The system as recited in claim 17, wherein the program instructions of the computer program further comprise:
executing said first build job after pausing said execution of said second build job.

19. The system as recited in claim 18, wherein the program instructions of the computer program further comprise:
resuming execution of said second build job in response to completion of said execution of said first build job.

20. The system as recited in claim 15, wherein said classifications of said one or more build jobs comprise one or more of the following: customer deliverables, production deployment, staging deployment, pull request builds, and development builds.
